(19) United States
(12) Patent Application Publication
(10) Pub. No.: US 2017/0094435 A1
(43) Pub. Date: Mar. 30, 2017

(54) AUDIO PLAYING METHOD, APPARATUS, AND SYSTEM FOR MULTIPLE PLAYING DEVICES

(71) Applicant: Guangdong Oppo Mobile Telecommunications Corp., Ltd., Dongguan (CN)

(72) Inventor: Shangbo Lin, Dongguan (CN)

(21) Appl. No.: 15/371,924

(22) Filed: Dec. 7, 2016

Related U.S. Application Data
(63) Continuation of application No. PCT/CN2015/096074, filed on Nov. 30, 2015.

(30) Foreign Application Priority Data
Sep. 2, 2015 (CN) 201510560215.3

(51) Int. Cl. H04R 29/00; H04R 27/00

(52) U.S. Cl. CPC H04R 29/007; H04R 27/00; H04R 2227/003; H04R 2227/005

(57) ABSTRACT

The present disclosure provides an audio playing method, an audio playing apparatus, and an audio playing system for multiple playing devices. The method includes establishing a data transmission connection between a playing device and a terminal according to a connection request sent by the terminal, determining a playing group that the playing device belongs to according to play group information stored in the playing device, and receiving audio data sent by the terminal and syncing the audio data to other playing devices within the playing group, by which all playing devices within the playing group can play the audio data synchronously.

### CROSS-REFERENCE TO RELATED APPLICATIONS

This application is a continuation of International Application No. PCT/CN2015/096074, filed on Nov. 30, 2015, which claims the priority to Chinese patent application No. 201510560215.3, filed on Sep. 2, 2015, the disclosures of both of which are herein incorporated by reference in their entireties.

### TECHNICAL FIELD

The present disclosure relates to audio playing technology, and particularly to an audio playing method, an audio playing apparatus, and an audio playing system for multiple playing devices.

### BACKGROUND

With the development of multimedia technology, a music system including more than one playing device is becoming more and more popular to consumers. In such a music system, a plurality of playing devices is connected to a private network in a wireless manner (e.g., an industrial standard such as IEEE802.11). This kind of private network provides an Internet Oriented export, which can be connected to one or more routers in connection with the Internet, whereby playing devices of a private network can access network music resources. After installing dedicated application software, terminals (such as smart phone, tablet, or personal computer, etc.) can access and manage the playing devices of the private network through the export, such as increasing or decreasing devices, searching for music, creating a playlist, and controlling various playing status.

How to determine which playing devices of the music system will be configured to play a song synchronously has become a problem that needs to be solved.

### SUMMARY

Disclosed herein are implementations of an audio playing method for multiple playing devices, comprising establishing a data transmission connection between a playing device and a terminal according to a connection request sent by the terminal, determining a playing group that the playing device belongs to according to play group information stored in the playing device, and receiving audio data sent by the terminal and syncing the audio data to other playing devices within the playing group, wherein all playing devices within the playing group are to play the audio data synchronously.

Disclosed herein are also implementations of an audio playing apparatus for multiple playing devices, comprising a data transmission connecting unit, configured to establish a data transmission connection between a playing device and a terminal according to a connection request sent by the terminal, a playing group determining unit, configured to determine a playing group that the playing device belongs to according to play group information stored in the playing device, and a receiving or transmitting unit, configured to receive audio data sent by the terminal and sync the audio data to other playing devices within the playing group, wherein all playing devices within the playing group are to play the audio data synchronously.

Disclosed herein are also implementations of an audio playing system for multiple playing devices, comprising a processor configured to execute the following program units: a data transmission connecting unit, configured to establish a data transmission connection between a playing device and a terminal according to a connection request sent by the terminal, a playing group determining unit, configured to determine a playing group that the playing device belongs to according to play group information stored in the playing device, and a receiving or transmitting unit, configured to receive audio data sent by the terminal and sync the audio data to other playing devices within the playing group, wherein all playing devices within the playing group are to play the audio data synchronously.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic view illustrating a connection relationship between a music system and a terminal;

FIG. 2 is a flowchart illustrating an audio playing method for multiple playing devices according to a first implementation of the present disclosure;

FIG. 3a is a flowchart illustrating an audio playing method for multiple playing devices according to a second implementation of the present disclosure;

FIG. 3b is a structure schematic diagram illustrating a playing device involved in the audio playing method for multiple playing devices according to a second implementation of the present disclosure;

FIG. 4 is a block diagram illustrating an audio playing apparatus for multiple playing devices according to a third implementation of the present disclosure; and

FIG. 5 is a block diagram illustrating the structure of the audio playing apparatus for multiple playing devices to the third implementation of the present disclosure.

### DETAILED DESCRIPTION

The present disclosure will be described in detail below in conjunction with implementations and accompanying drawings. It should be appreciated that specific implementations described herein are for illustration only and are not intended for limitation of the present disclosure. It should also be noted that, for ease of description, only parts rather than all of the structures related to the present disclosure are illustrated in the accompanying drawings.

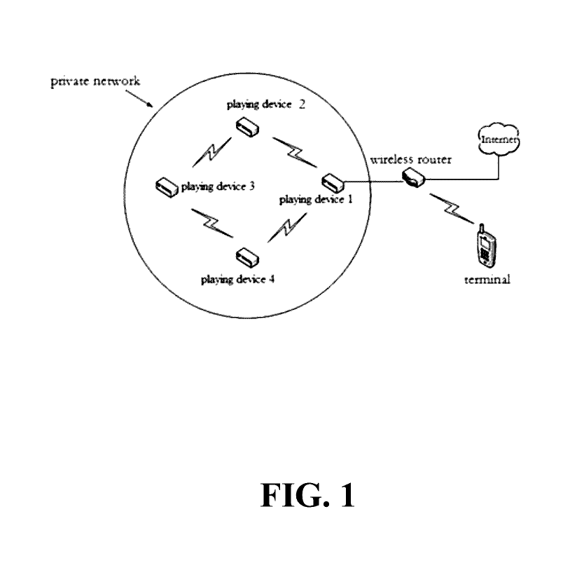

A music system including a plurality of playing devices can operate as a playing group, in other words, all playing devices of the music system can play the same song synchronously. As illustrated in FIG. 1, Playing Device 1, Playing Device 2, Playing Device 3, and Playing Device 4 forms a music system and a communication connection is established among them in a wireless manner. Playing Device 1 establishes a wired or wireless connection to a wireless router which in turn connects with the Internet and LAN (Local Area Network). Playing Device 1 is a master device of the music system while other playing devices are slave devices. After connecting to the wireless router, a terminal has dedicated application installed can access and control the playing devices of the private network of the music system via the application. The terminal will send information of a song which is desired to be played and selected by a user to Playing Device 1, the information of the song can be name of the song, a storage location of the song on a network music server, or URL (Uniform Resource Locator). Playing Device 1 can connect to the network music server according to the information of the song and further download and decode audio data of the song. Not only being played at Playing Device 1, the decoded audio data will also be sent to Playing Device 2, Playing Device 3, and Playing Device 4 of the private network, whereby all of the four playing devices in the group will play the song synchronously.

In addition, playing devices of a music system can be divided into several playing groups for playing different music respectively. For example, in a music system, there are six playing devices, i.e., Playing Devices A, B, C, D, E, and F, among which the playing devices A and B form Playing Group 1, Playing Devices C and D form Playing Group 2, and Playing Devices E and F form Playing Group 3. Playing Devices A and B in Playing Group 1 play the same song synchronously, Playing Devices C and D in Playing Group 2 play the same song synchronously, and Playing Devices E and F in Playing Group 3 play the same song synchronously. However, Playing Group 1, Group 2, and Group 3 are independent of each other and they can play the same or different songs. Each playing group can be controlled by the same or different users.

In addition to the above-described manner of acquiring the audio data via the wireless router, a playing device of the music system can also obtain the audio data from the terminal via data transmission (such as Bluetooth, Infra-red) either. For example, a terminal outside the music system can establish a Bluetooth connection with any playing device of the music system and send audio data to the connected playing device via Bluetooth. However, as to the audio data acquired in this way, the operation of other playing devices except for the Bluetooth connected playing device in the music system cannot be determined. That is to say, it is unable to determine whether the audio data will be played by the connected playing device only, by more than one playing device, or by all of the playing devices of the music system, thereby affecting user listening experience.

In light of this, an audio playing technical scheme for multiple playing devices is provided in the present disclosure, which will be described below in detail with refer to the accompanying drawings.

### First Implementation

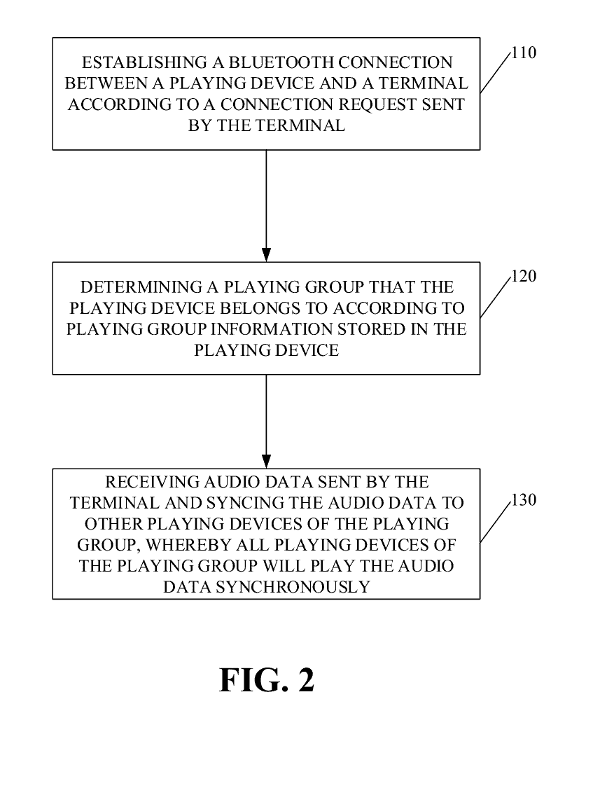

FIG. 2 is a flowchart illustrating an audio playing method for multiple playing devices according to the first implementation of the present disclosure. This implementation is applicable to the situation where playing devices of a music system should be coordinated to process audio data acquired via data transmission such as Bluetooth. There can be an audio playing device arranged in each playing device of the multiple playing devices, and the method can be performed by the audio playing device(s). Hereafter, take Bluetooth as an example for ease of explanation; however, the present disclosure is not limited thereto, Point-to-Point (P2P), Infra-red, 2.4 GHz, and other technology similar to Bluetooth can also be used herein for data transmission.

As illustrated in FIG. 2, the method can begin at block 101.

At block 110, a Bluetooth connection is established between a playing device and a terminal according to a connection request sent by the terminal.

The terminal has a Bluetooth unit and it can transmit, via Bluetooth, audio data downloaded or of its own to the playing device with which a connection has been established. For example, the terminal can be an audio device. The audio device can search playing devices that can be connected within a certain range via Bluetooth. If any playing device that can be connected is found, a connection request will be send thereto. The playing device being found will establish a Bluetooth connection with the terminal according to the connection request sent by the terminal.

At block 120, a playing group that the playing device belongs to is determined according to play group information stored in the playing device.

The playing group information includes playing group name, name of playing device included in the playing group, and Internet Protocol address (IP address) of playing device included in the playing group. The playing group information is stored in each playing device of the playing group; the playing device can determine whether it belongs to any playing group and which playing group it belongs to by querying playing information stored by the playing device itself. For example, the playing group information stored in the playing device is inquired; it is determined that the playing device does not belong to any playing group if the playing group information does not include “playing group name”; otherwise, it is determined that the playing device belongs to a playing group corresponding to “playing group name” if “playing group name” is included in the playing group information.

At block 130, audio data sent by the terminal is received and synced to other playing devices of the playing group, whereby all playing devices of the playing group will play the audio data synchronously.

The terminal establishes a Bluetooth connection with a playing device and sends audio data to it via Bluetooth. The playing device receives the audio data and determines the playing group it belongs to according to play group information stored by the playing device itself. The playing device can further determine the IP address or device identification of the other playing devices from the playing group information and sync the audio data received to other playing devices of the playing group according to the IP address determined whereby all playing devices of the playing group can play the audio data synchronously. It is understandable that, in the present disclosure, when referring to “play audio data”, it can be comprehended as play the song or music corresponding to the audio data.

If the playing device does not belong to any playing group, the playing device will play the audio data individually.

With the aid of the technical scheme of the implementation of the present disclosure, by establishing a Bluetooth connection between a playing device and a terminal according to a connection request sent by the terminal, determining a playing group that the playing device belongs to according to play group information stored in the playing device; and receiving audio data sent by the terminal and syncing the audio data to other playing devices of the playing group, all playing devices of the playing group will play the audio data synchronously. Therefore, the problem that it is unable for the playing device to determine whether to transmit the audio data to other playing devices upon receiving the audio data via Bluetooth is resolved; playing devices of a music system can be coordinated to process audio data acquired via Bluetooth, whereby user listening experience can be improved.

Based on the above technical scheme, before determining the playing group that the playing device belongs to according to the playing group information stored in the playing device, the method can further include: grouping operation is performed on a plurality of playing devices included in a music system, and storing the playing group information (in other words, grouping information) in each playing device included in a playing group corresponding to the playing group information. In such a manner, personalized audio file playing demand of the user can be met by grouping the music system according to actual needs of the user.

### Second Implementation

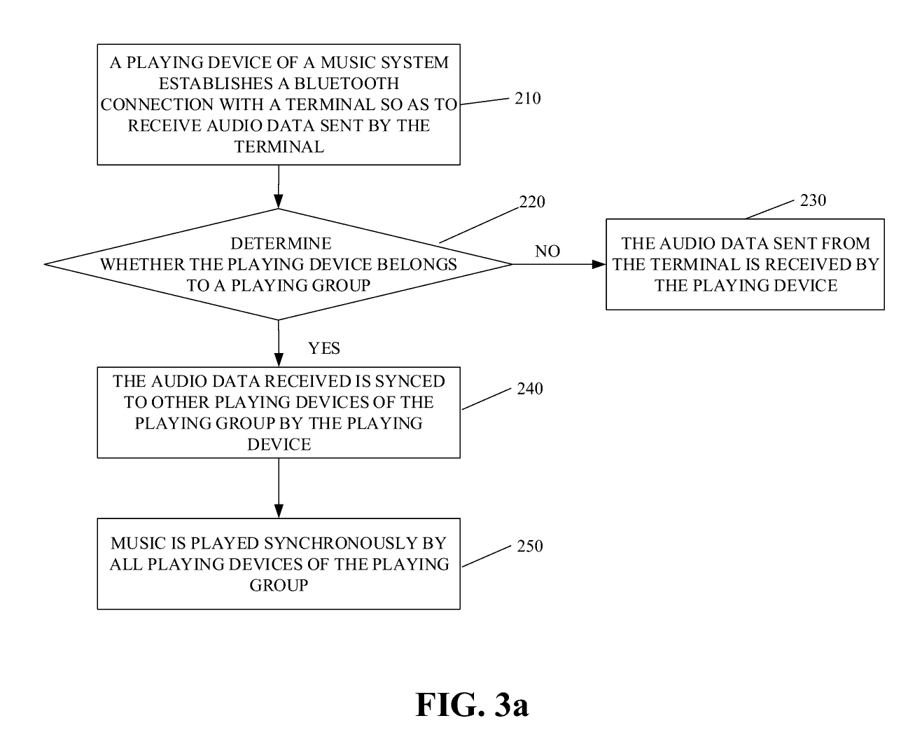

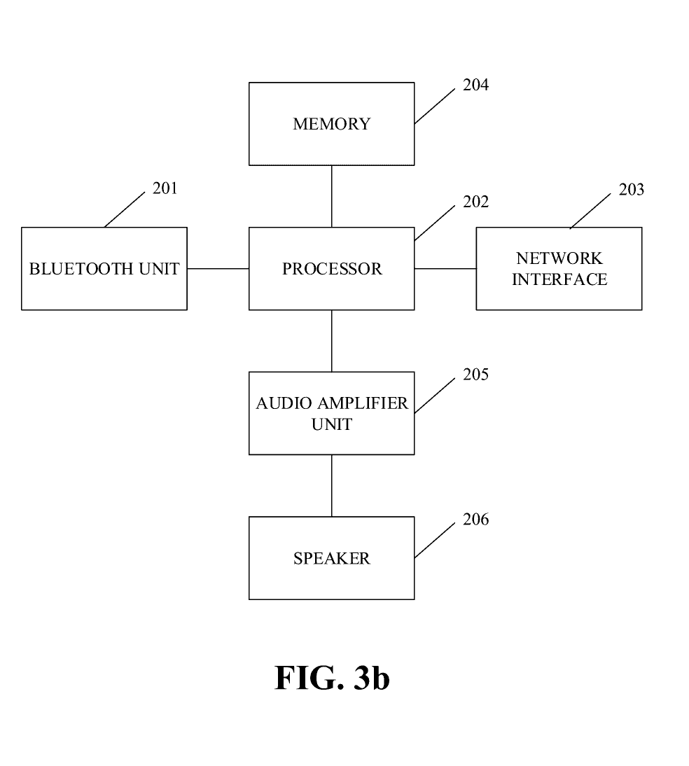

FIG. 3a is a flowchart illustrating an audio playing method for multiple playing devices according to the second implementation of the present disclosure; the playing device can have a structure illustrated in FIG. 3b.

As illustrated in FIG. 3b, the playing device includes a processor 202, a data transmission unit such as a Bluetooth unit 201, a network interface 203, an audio amplifier unit 205, a speaker 206, and a memory 204. The Bluetooth unit 201 is configured to realize Bluetooth communication, whereby the playing device can establish a Bluetooth connection with a terminal (such as a smart phone) equipped with Bluetooth function via Bluetooth. The playing device can acquire audio data and/or control data via Bluetooth. The Bluetooth unit 201 can transmit the audio data and/or control data acquired to the processor 202. Thereafter, the processor 202 can send, via the Bluetooth unit 201, the audio data and/or control data to other devices equipped with a Bluetooth unit 201. The processor 202 is the core of the playing device; it can execute a control program and communicate with various peripheral function units as well as coordinate and control each unit. The network interface 203 can be a wired network interface or a wireless network interface in line with 802.11 standards. The processor 202 can be coupled to the Internet via the network interface 203 so as to acquire network streaming media audio data. Multiple playing devices can form a private network of a wireless music system via the network interface 203, and synchronized music playing can be achieved. Normally, the terminal can connect to the music system through a wireless network (e.g., WIFI) and control the music system as well as playing devices of the music system. The processor 202 performs decoding and/or D/A (digital-analog) conversion on the audio data acquired, and sends the converted analog audio signal to the audio amplifier unit 205; the audio amplifier unit 205 in turn perform power amplification on the analog audio signal sent by the processor 202 so as to drive the speaker 206. Sound is restored and played by the speaker 206 upon receiving the analog audio signal sent by the audio amplifier unit 205, and in practice, there can be one or more speakers 206. The memory 204 is configured to store programs executed by the processor 202 as well as configuration data of the music system, such as network connection data, volume information, grouping information, and playlist.

As illustrated in FIG. 3a, the method can begin at block 210.

At block 210, a playing device of a music system establishes a Bluetooth connection with a terminal so as to receive audio data sent by the terminal.

For example, the playing device of the music system establishes a Bluetooth connection with the terminal and receives audio data sent by the terminal via the Bluetooth unit 201.

At block 220, upon receiving the audio data sent by the terminal via Bluetooth, the playing device will query grouping information stored in the memory 204 so as to determine whether it belongs to any playing group; proceed to block 230 if the playing device does not belong to any playing group, otherwise, proceed to block 240.

At block 230, the audio data sent from the terminal is received by the playing device.

In this condition, the playing device does not belong to any playing group, the processor 202 of the playing device will perform decoding and/or D/A (digital-analog) conversion on the audio data acquired, and send the converted analog audio signal to the audio amplifier unit 205, which will in turn perform power amplification on the analog audio signal sent by the processor 202 so as to drive the speaker 206. The speaker 206 can restore and play the audio data after receiving the analog audio signal sent by the audio amplifier unit 205.

At block 240, the audio data received is synced to other playing devices of the playing group by the playing device.

In this condition, the playing device belongs to a playing group and it can send the audio data received to other playing devices of the playing group according to the Internet Protocol address (IP address) of the other playing devices.

At block 250, music is played synchronously by all playing devices of the playing group.

With regard to any playing device in the playing group, through the processor 202, decoding and/or D/A (digital to analog) conversion can be performed on the audio data acquired; the converted analog audio signal will be send to the audio amplifier unit 205 such that the audio amplifier unit 205 can perform power amplification on the analog audio signal sent by the processor 202 in order to drive the speaker 206 to make it sound. The analog audio signal sent by the audio amplifier unit 205 will be restored and played by the speaker 206 upon reception thereof, and synchronized music playing of all playing devices of the playing group can be achieved.

### Third Implementation

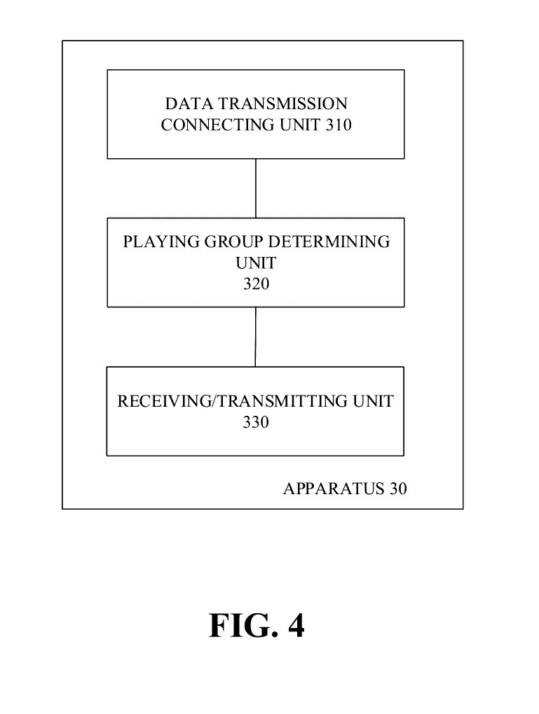

FIG. 4 is a block diagram illustrating an audio playing apparatus for multiple playing devices according to a third implementation of the present disclosure. The apparatus includes a data transmission connecting unit 310, a playing group determining unit 320, and a receiving/transmitting unit 330.

The data transmission connecting unit 310, which can be a communicator such as a Bluetooth communicator, is configured to establish a Bluetooth connection between a playing device and a terminal according to a connection request sent by the terminal;

The playing group determining unit 320, which can be a processor, is configured to determine a playing group that the playing device belongs to according to play group information stored in the playing device.

The receiving/transmitting unit 330, which can be a transceiver, is configured to receive audio data sent by the terminal and sync the audio data to other playing devices of the playing group, whereby all playing devices of the playing group will play the audio data synchronously.

In this technical scheme, the data transmission connecting unit 310 establishes a Bluetooth connection between a playing device and a terminal according to a connection request sent by the terminal, the playing group determining unit 320 determines a playing group that the playing device belongs to according to play group information stored in the playing device; the receiving/transmitting unit 330 receives audio data sent by the terminal and syncs the audio data to other playing devices of the playing group, whereby all playing devices of the playing group can play the audio data synchronously. Therefore, the problem that it is unable for the playing device to determine whether to transmit the audio data to other playing devices upon receiving the audio data via Bluetooth is resolved; playing devices of a music system can be coordinated to process audio data acquired via Bluetooth, whereby user listening experience can be improved.

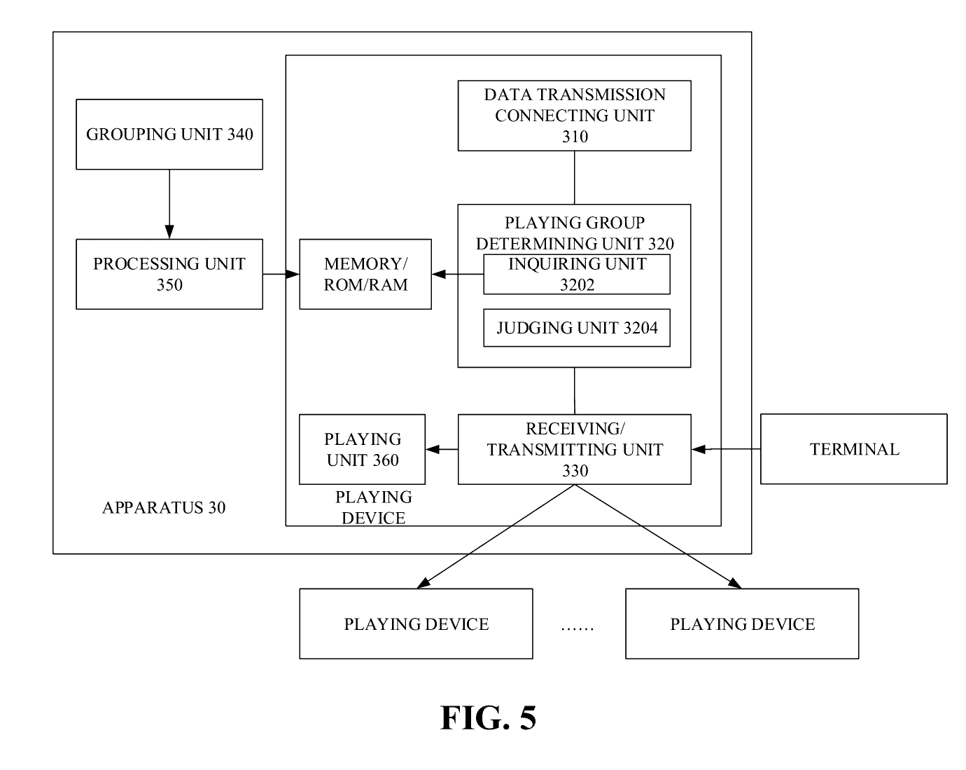

As illustrated in FIG. 5, the apparatus further includes a grouping unit 340 and a processing unit 350 which can be both arranged in a processor for example. The grouping unit 340 is configured to perform grouping operation on the music system, i.e., perform grouping operation on the multiple playing devices included in the music system, so as to obtain more than one playing group. The processing unit 350 is configured to store playing group information of each playing group in the playing devices included in the playing group correspondingly. For example, the grouping information can be stored in a Memory, ROM, or RAM of a playing device.

As an implementation, the operation of the grouping unit and the processing unit described above can be performed before determining the playing group that the playing device belongs to according to the playing group information stored in the playing device by the playing group determining unit 320.

The playing group information includes playing group name, name of playing device included in the playing group, and Internet Protocol address (IP address) of playing device included in the playing group.

Additionally, the playing group determining unit 320 further includes an inquiring unit 3202 and a judging unit 3204.

The inquiring unit 3202 is configured to inquire whether the playing group information stored in the playing device comprising “playing group name”.

The judging unit 3204 is configured to determine that the playing device does not belong to any playing group if the playing group information does not include “playing group name”; or configured to determine that the playing device belongs to a playing group corresponding to “playing group name” if the playing group information includes “playing group name”.

As illustrated in FIG. 5, the apparatus further includes a playing unit 360, which can be a speaker and/or speaker controller, and is configured to play the audio data via the playing device individually if the playing device does not belong to any playing group.

The audio playing apparatus for multiple playing devices described above, which has corresponding function units capable of performing methods and obtaining corresponding advantages, can be configured to perform the audio playing method for multiple playing devices according to any implementation of the present disclosure.

In order to implement the implementations described above, it is provided storage medium storing application programs, when executed on a data-processing apparatus, the programs are adapted to perform the audio playing method for multiple playing devices according to any implementation of the present disclosure.

The term “computer readable storage medium” can be referred to as a non-volatile computer-readable storage medium or tangible computer-readable medium either. Examples of computer readable storage medium include but not limited to magnetic hard disk drive, solid state hard disk, flash memory, USB thumb drive, RAM, ROM, magneto-optical disk, and the register file of the processor.

The term “computer readable-storage medium” also refers to various recording media capable of being accessed by a computer device via a network or communication link. Furthermore, “computer readable storage medium” can be multiple computer readable storage mediums of the same computer system or distributed among multiple computer systems or computing devices.

In order to implement the implementations described above, it is further provided an audio playing system for multiple playing devices, which includes a hardware processor configured to execute the program or functional units included in the audio playing apparatus for multiple playing devices according to the implementation of the present disclosure.

The foregoing description is merely explanation of implementations rather than limitation of the present disclosure. For those skilled in the art, various modifications and alterations can be made to the present disclosure. Any modification, equivalent substitution, improvement or the like made within the spirit and principle of the present disclosure shall fall into the protection scope of the present disclosure.

What is claimed is:

1. A method for audio playing for multiple playing devices, comprising:
establishing a data transmission connection between a playing device and a terminal according to a connection request sent by the terminal;
determining a playing group that the playing device belongs to according to play group information stored in the playing device; and
receiving audio data sent by the terminal and syncing the audio data to other playing devices within the playing group, wherein all playing devices within the playing group are to play the audio data synchronously.

2. The method of claim 1, wherein before determining the playing group that the playing device belongs to according to the playing group information stored in the playing device, the method further comprises:
dividing a plurality of playing devices comprised in a music system into more than one playing group, and storing the playing group information of each playing group in each playing device comprised in the playing group correspondingly.

3. The method of claim 1, wherein the playing group information comprises a playing group name, the playing group comprising a name of a playing device, and an Internet Protocol (IP) address of the playing device.

4. The method of claim 3, wherein before determining the playing group that the playing device belongs to according to play group information stored in the playing device, the method further comprises:
inquiring whether the playing group information stored in the playing device comprises the playing group name; and
determining that the playing device belongs to a playing group corresponding to the playing group name when the playing group information comprises the playing group name.

5. The method of claim 1, further comprising:
playing the audio data via the playing device individually when the playing device does not belong to any playing group.

6. An apparatus for audio playing for multiple playing devices, comprising:
a data transmission connecting unit, configured to establish a data transmission connection between a playing device and a terminal according to a connection request sent by the terminal;
a playing group determining unit, configured to determine a playing group that the playing device belongs to according to play group information stored in the playing device; and
a receiving transmitting unit, configured to receive audio data sent by the terminal and sync the audio data to other playing devices within the playing group, wherein all playing devices within the playing group are to play the audio data synchronously.

7. The apparatus of claim 6, further comprising:
a grouping unit, configured to divide a plurality of playing devices comprised in a music system into more than one playing group; and
a processing unit, configured to store playing group information of each playing group in each playing device comprised in the playing group correspondingly.

8. The apparatus of claim 6, wherein the playing group information comprises a playing group name, the playing group comprising a name of a playing device, and an Internet Protocol (IP) address of the playing device.

9. The apparatus of claim 8, wherein the playing group determining unit further comprises:
an inquiring unit, configured to inquire whether the playing group information stored in the playing device comprises the playing group name; and
a judging unit, configured to determine that the playing device belongs to a playing group corresponding to the playing group name when it is inquired that the playing group information comprises the playing group name by the inquiring unit.

10. The apparatus of claims 6, further comprising:
a playing unit, configured to play the audio data via the playing device individually when the playing device does not belong to any playing group.

11. A system for audio playing for multiple playing devices, comprising a processor configured to execute the following program units:
a data transmission connecting unit, configured to establish a data transmission connection between a playing device and a terminal according to a connection request sent by the terminal;
a playing group determining unit, configured to determine a playing group that the playing device belongs to according to play group information stored in the playing device; and
a receiving or transmitting unit, configured to receive audio data sent by the terminal and sync the audio data to other playing devices within the playing group, wherein all playing devices within the playing group are to play the audio data synchronously.

12. The system of claim 11, wherein the processor is further configured to execute the following program units:
a grouping unit, configured to perform grouping operation on a plurality of playing devices comprised in a music system to obtain more than one playing group; and
a processing unit, configured to store playing group information of each playing group in each playing device comprised in the playing group correspondingly.

13. The system of claim 11, wherein the playing group information comprises a playing group name, the playing group comprising a name of a playing device, and Internet Protocol (IP) address of the playing device.

14. The system of claim 13, wherein the processor is further configured to execute the following program units comprised in the playing group determining unit:
an inquiring unit, configured to inquire whether the playing group information stored in the playing device comprises the playing group name; and
a judging unit, configured to determine that the playing device belongs to a playing group corresponding to the playing group name when it is inquired that the playing group information comprises the playing group name by the inquiring unit.
